(19) United States
(12) Patent Application Publication
(10) Pub. No.: US 2008/0162148 A1
(43) Pub. Date: Jul. 3, 2008

(54) Scalable Encoding Apparatus And Scalable Encoding Method

(75) Inventors: Michiyo Goto, Tokyo (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/722,015

(22) PCT Filed: Dec. 26, 2005
(86) PCT No.: PCT/JP2005/023812

§ 371 Date: Jun. 18, 2007

(30) Foreign Application Priority Data
Dec. 28, 2004 (JP) 2004-381492
May 31, 2005 (JP) 2005-160187

(51) Int. Cl. G10L 19/00

(52) U.S. Cl. 704/500; 704/E19.001

(57) ABSTRACT

A scalable encoding apparatus wherein the degradation of sound quality of a decoded signal can be prevented, while the encoding rate and the circuit scale can be reduced. In this apparatus, an L-channel signal processing part (105-1) uses L-channel space information to generate an L-channel signal (L1) to produce a processed signal (L2) that is similar to a monophonic signal (M1). An L-channel processed signal combining part (106-1) uses both the processed signal (L2) and a sound source signal (S1) generated by a sound source signal generating part (104) to generate a combined signal (L3). An R-channel signal processing part (105-2) and an R-channel processed signal combining part (106-2) operate similarly. A distortion minimizing part (103) controls the sound source signal generating part (104) to generate such a common sound source signal (S1) that the sum of the encoding distortions of combined signals (M2,L3,R3) is minimized.

### TECHNICAL FIELD

The present invention relates to a scalable coding apparatus and a scalable coding method that perform coding on a stereo signal.

### BACKGROUND ART

Speech signals in a mobile communication system are now mainly communicated by a monaural scheme (monaural communication), such as in speech communication by mobile telephone. However, it will be possible in the future to maintain adequate bandwidth for transmitting a plurality of channels by further increasing transmission bit rates, as in a fourth-generation mobile communication system. It is therefore expected that communication by a stereo scheme (stereo communication) will be widely used in speech communication as well.

For example, considering the increasing number of users who enjoy stereo music by storing music in portable audio players that are equipped with a HDD (hard disk) and attaching stereo earphones, headphones, or the like to the player, it is anticipated that portable telephones will be combined with music players in the future, and that a lifestyle that involves speech communication by a stereo scheme while using stereo earphones, headphones, or other equipment will become prevalent. The use of stereo communication is also anticipated because of the ability to create high-fidelity conversation in currently popularized video conferences and other settings.

Meanwhile, with mobile communication systems and wired communication schemes etc., it is typical to transmit information at low bit rates by encoding speech signals to be transmitted in advance, to reduce the system load. As a result, recently, note is being taken of technology for encoding stereo speech signals. For example, coding technology exists for increasing the coding efficiency for encoding predictive residual signals to which weight of CELP coding for stereo speech signals is assigned, using cross-channel prediction (refer to non-patent document 1).

When stereo communication becomes common, it can naturally be assumed that monaural communication will also be in use. This is because monaural communication has a low bit rate, and a lower cost of communication can therefore be anticipated. A mobile telephone that is adapted only for monaural communication will also be inexpensive due to smaller circuit scales, and users who do not need high-quality speech communication will purchase mobile telephones that are adapted only for monaural communication. Mobile telephones that are adapted for stereo communication will also coexist in a single communication system with mobile telephones that are adapted for monaural communication, and the communication system will have to accommodate both stereo communication and monaural communication. Since a mobile communication system exchanges communication data through the use of radio signals, portions of the communication data are sometimes lost due to the environment of the propagation channel. Therefore, the ability to restore the original communication data from the residual received data even when portions of the communication data are lost is an extremely useful function for a mobile telephone to have.

This type of encoding can support both stereo communication and monaural communication and is capable of restoring the original communication data from residual received data even when part of the communication data is lost. An example of a scalable coding apparatus that has this capability is disclosed in Non-patent Document 2, for example.
Non-patent document 1: Ramprashad, S. A. “Stereophonic CELP coding using cross channel prediction”, Proc. IEEE Workshop on Speech Coding, Pages: 136-138, (17-20 Sep. 2000)
Non-patent Document 2: ISO/IEC 14496-3:1999 (B. 14 Scalable AAC with core coder)

### DISCLOSURE OF INVENTION

### Problems to be Solved by the Invention

However, the technology disclosed in non-patent document 1 has separate adaptive codebooks and fixed codebooks etc. for two channel speech signals, generates separate excitation signals each channel, and generates a synthesized signal. Namely, CELP coding of speech signals is carried out each channel, and encoded information obtained for each channel is outputted to the decoding side. There is therefore a problem that encoding parameters are generated for the number of channels, so that, when the encoding bit rate increases, circuit scale of the coding apparatus also increases. Further, if the number of adaptive codebooks and fixed codebooks etc. is reduced, the encoding bit rate also falls and the circuit scale is also reduced. However, conversely, substantial sound quality deterioration occurs in the decoded signal. This problem is also the same for the scalable coding apparatus disclosed in non-patent document 2.

It is therefore an object to provide a scalable coding apparatus and scalable coding method that reduce the coding rate and circuit scale of the coding apparatus, while preventing deterioration in sound quality of decoded signals.

### Means for Solving the Problem

The present invention adopts a configuration where scalable coding apparatus has: a monaural signal generating section that generates a monaural signal from a first channel signal and a second channel signal; a first channel processing section that processes the first channel signal and generates a first channel processed signal analogous to the monaural signal; a second channel processing section that processes the second channel signal and generates a second channel processed signal analogous to the monaural signal; a first encoding section that encodes part or all of the monaural signal, the first channel processed signal, and the second channel processed signal, using a common excitation; and a second encoding section that encodes information relating to the process in the first channel processing section and the second channel processing section.

Here, the first channel signal and the second channel signal refer to the L-channel signal and the R-channel signal of a stereo signal, or designate these signals in reverse.

### Advantageous Effect of the Invention

According to the present invention, while preventing deterioration in quality of decoded signals, it is possible to reduce the coding rate and circuit scale of the coding apparatus.

### BRIEF DESCRIPTION OF DRAWINGS

FIG. 1 is a block diagram showing the main configuration of a scalable coding apparatus according to Embodiment 1;

FIG. 2 is a view showing an example of a waveforms from the same source signal which are acquired at different positions;

FIG. 3 is a block diagram showing the configuration of the scalable coding apparatus of Embodiment 1 in more detail;

FIG. 4 is a block diagram showing a detailed internal configuration of a monaural signal generating section according to Embodiment 1;

FIG. 5 is a block diagram showing the main configuration of an internal configuration of a spatial information processing section according to Embodiment 1;

FIG. 6 is a block diagram showing the main parts of an internal configuration for a distortion minimizing section according to Embodiment 1;

FIG. 7 is a block diagram showing the main configuration inside an excitation signal generation section according to Embodiment 1;

FIG. 8 is a flowchart illustrating the step of scalable coding processing according to Embodiment 1;

FIG. 9 is a block diagram showing the detailed configuration of a scalable coding apparatus according to Embodiment 2;

FIG. 10 is a block diagram showing the main configuration inside a spatial information assigning section according to Embodiment 2;

FIG. 11 is a block diagram showing the main configuration inside a distortion minimizing section according to Embodiment 2; and

FIG. 12 is a flowchart illustrating the steps of scalable coding processing according to Embodiment 2.

### BEST MODE FOR CARRYING OUT THE INVENTION

Embodiments of the present invention will be described below in detail with reference to the accompanying drawings. Here a case will be explained as an example where the stereo speech signal composed of two channels of an L channel and an R channel is encoded.

### Embodiment 1

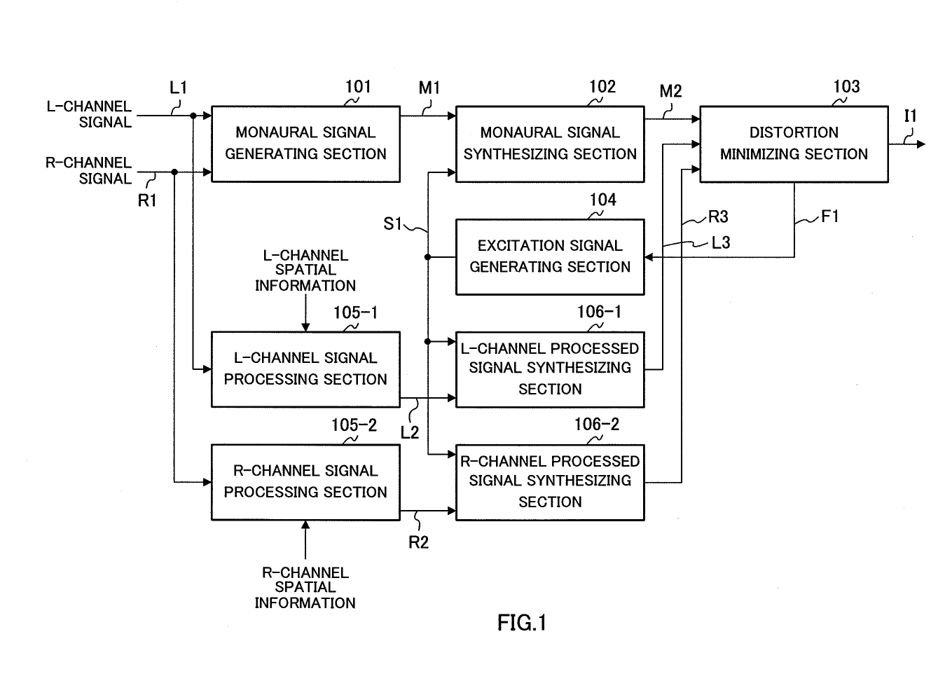

FIG. 1 is a block diagram showing the main configuration of a scalable coding apparatus according to Embodiment 1. The scalable coding apparatus according to this embodiment carries out encoding of a monaural signal in a first layer (base layer), carries out encoding of an L-channel signal and an R-channel signal in a second layer, and transmits encoding parameters obtained at each layer to the decoding side.

The scalable coding apparatus according to this embodiment is comprised of monaural signal generating section 101, monaural signal synthesizing section 102, distortion minimizing section 103, excitation signal generating section 104, L-channel signal processing section 105-1, L-channel processed signal synthesizing section 106-1, R-channel signal processing section 105-2, and R-channel processed signal synthesizing section 106-2. Monaural signal generating section 101 and monaural signal synthesizing section 102 are classified to the first layer, and L-channel signal processing section 105-1, L-channel processed signal synthesizing section 106-1, R-channel signal processing section 105-2 and R-channel processed signal synthesizing section 106-2 are classified to the second layer. Further, distortion minimizing section 103 and excitation signal generating section 104 are common for the first layer and the second layer.

An outline of the operation of the scalable coding apparatus will be described below.

The input signal is a stereo signal comprised of L-channel signal L1 and R-channel signal R1, and, in the first layer, the scalable coding apparatus generates a monaural signal M1 from these L-channel signal L1 and R-channel signal R1 and subjects this monaural signal M1 to predetermined encoding.

On the other hand, in the second layer, the scalable coding apparatus subjects the L-channel signal L1 to processing process (described later), generates an L-channel processed signal L2 analogous to a monaural signal, and subjects this L-channel processed signal L2 to predetermined encoding. Similarly, in the second layer, the scalable coding apparatus subjects the R-channel signal R1 to processing process (described later), generates an R-channel processed signal R2 analogous to a monaural signal, and subjects this R-channel processed signal R2 to predetermined encoding.

This “predetermined encoding” refers to encoding implemented in common for monaural signals, L-channel processed signal, and the R-channel processed signal, where a single encoding parameter that is common to the three signals (or a set of encoding parameters in the case that a single excitation is expressed using a plurality of encoding parameters) is obtained, so that the coding rate is reduced. For example, in an coding method where an excitation signal analogous to the inputted signal is generated, and encoding is carried out by obtaining information specifying to this excitation signal, encoding is carried out by allocating a single (or set of) excitation signal(s) to the three signals (monaural signal, L-channel processed signal, and R-channel processed signal). The L-channel signal and R-channel signal are both analogous to a monaural signal, so that it is possible to encode the three signals using common encoding processing. In this configuration, the inputted stereo signal may be a speech signal or may be an audio signal.

Specifically, the scalable coding apparatus according to this embodiment generates respective synthesized signals (M2, L3, R3) for monaural signal M1, L-channel processed signal L2, and R-channel processed signal R2, and, by comparing these signals to the original signals, obtains encoding distortion for the three synthesized signals. An excitation signal that makes the sum of the three obtained encoding distortions a minimum is then searched for, and information specifying this excitation signal is transmitted to the decoding side as encoding parameter I1, so as to reduce the encoding bit rate.

Further, although not shown in the drawings, the decoding side requires information about the processing applied to the L-channel signal and the processing applied to the R-channel signal, in order to decode the L-channel signal and R-channel signal. The scalable coding apparatus of this embodiment therefore carries out separate encoding of this processing-related information for transmission to the decoding side.

Next, a description will be given of processing applied to the L-channel signal and the R-channel signal.

Typically, even with speech signals or audio signals from the same source, it is shown that the waveform of a signal exhibits different characteristics depending on the position where the microphone is placed, i.e. depending on the position where this stereo signal is sampled (received). As a simple example, energy of a stereo signal is attenuated with the distance from the source, delays also occur in the arrival time, and different waveforms are exhibited depending on sampling positions. In this way, the stereo signal is substantially affected by spatial factors such as the sound-sampling environment.

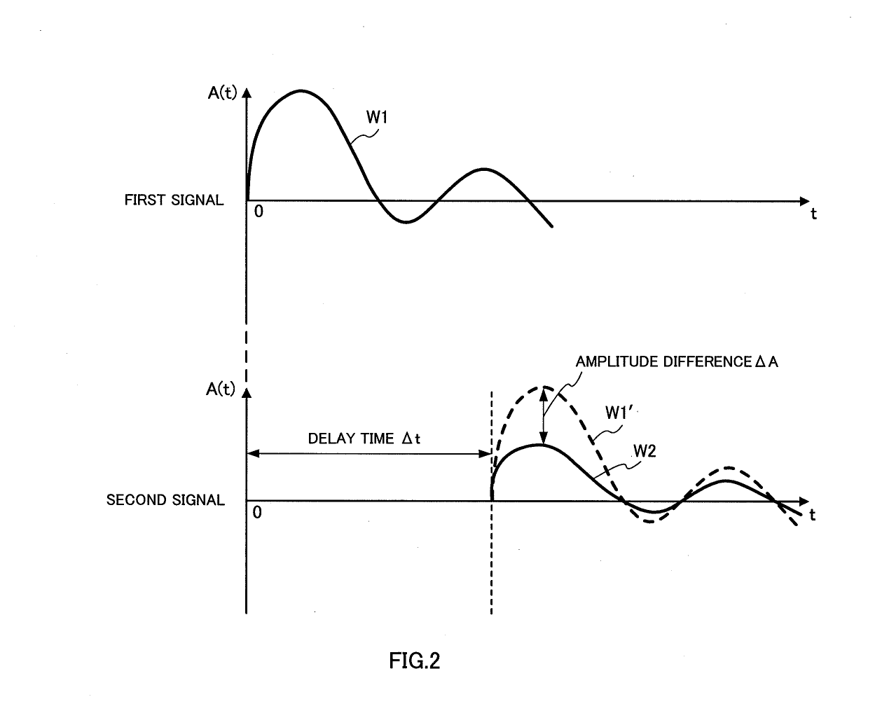

FIG. 2 is a view showing an example of waveforms of signals (first signal W1 and second signal W2)from the same source which are sampled at two different positions.

As shown in the drawing, the first signal and the second signal exhibit different characteristics. The phenomenon of showing different characteristics may be interpreted as a result of sampling of a signal using sound sampling equipment such as a microphone after different spatial characteristics depending on the sound sampling position are added to original signal waveform. This characteristic will be referred to as “spatial information” in this specification. This spatial information gives a broad-sounding image to the stereo signal. Further, the first and second signals are such that spatial information is applied to signals from the same source and have the following properties. For example, in the example in FIG. 2, when the first signal W1 is delayed by time Δt , then this gives signal W1′. Next, if the amplitude of signal W1′ is reduced by a fixed proportion and the amplitude difference ΔA is eliminated, signal W1′, being a signal from the same source, ideally matches with the second signal W2. Namely, it is possible to substantially eliminate differences in the characteristics (differences in waveforms) of the first signal and the second signal by subjecting the spatial information contained in the speech signal or audio signal to correction processing. As a result it is possible to make the waveforms of both stereo signals analogous. This spatial information will be described in more detail later.

In this embodiment, it is possible to generate L-channel processed signal L2 and R-channel processed signal R2 analogous to monaural signal M1, by applying processing for correcting each item of spatial information to the L-channel signal L1 and the R-channel signal R1. As a result, it is possible to share the excitation used in encoding processing, and furthermore it is possible to obtain accurate encoded information by generating a single (or set of) coding parameter(s) without generating respective coding parameters for the three signals as encoding parameters.

Next, a description will be given of the operation of the scalable coding apparatus for each block.

Monaural signal generating section 101 generates monaural signal M1 having in-between of both signals from the inputted L-channel signal L1 and R-channel signal R1 for output to monaural signal synthesizing section 102.

Monaural signal synthesizing section 102 generates synthesized signal M2 of the monaural signal using monaural signal M1 and excitation signal S1 generated by excitation signal generating section 104.

L-channel signal processing section 105-1 acquires L-channel spatial information for the difference between L-channel signal L1 and monaural signal M1, subjects the L-channel signal L1 to the above processing process using this information, and generates L-channel processed signal L2 analogous to monaural signal M1. This spatial information will be further described in more detail later.

L-channel processed signal synthesizing section 106-1 generates synthesized signal L3 of L-channel processed signal L2 using L-channel processed signal L2 and excitation signal S1 generated by excitation signal generating section 104.

The operation of R-channel signal processing section 105-2 and R-channel processed signal synthesizing section 106-2 is basically the same as the operation of L-channel signal processing section 105-1 and L-channel processed signal synthesizing section 106-1 and therefore will not be described. However, the target of processing in L-channel signal processing section 105-1 and L-channel processed signal synthesizing section 106-1 is the L-channel, and the target of processing in R-channel signal processing section 105-2 and R-channel processed signal synthesizing section 106-2 is the R-channel.

Distortion minimizing section 103 controls excitation signal generating section 104 to generate excitation signal S1 that makes the sum of the encoding distortions for synthesized signals (M2, L3, R3) a minimum. This excitation signal S1 is common to the monaural signal, L-channel signal, and R-channel signal. Further, it is also necessary to have the original signals M1, L2, and R2 as input in order to obtain the encoding distortions of synthesized signals but this is omitted in this drawing for ease of description.

Excitation signal generating section 104 generates excitation signal S1 common to the monaural signal, L-channel signal, and R-channel signal under the control of distortion minimizing section 103.

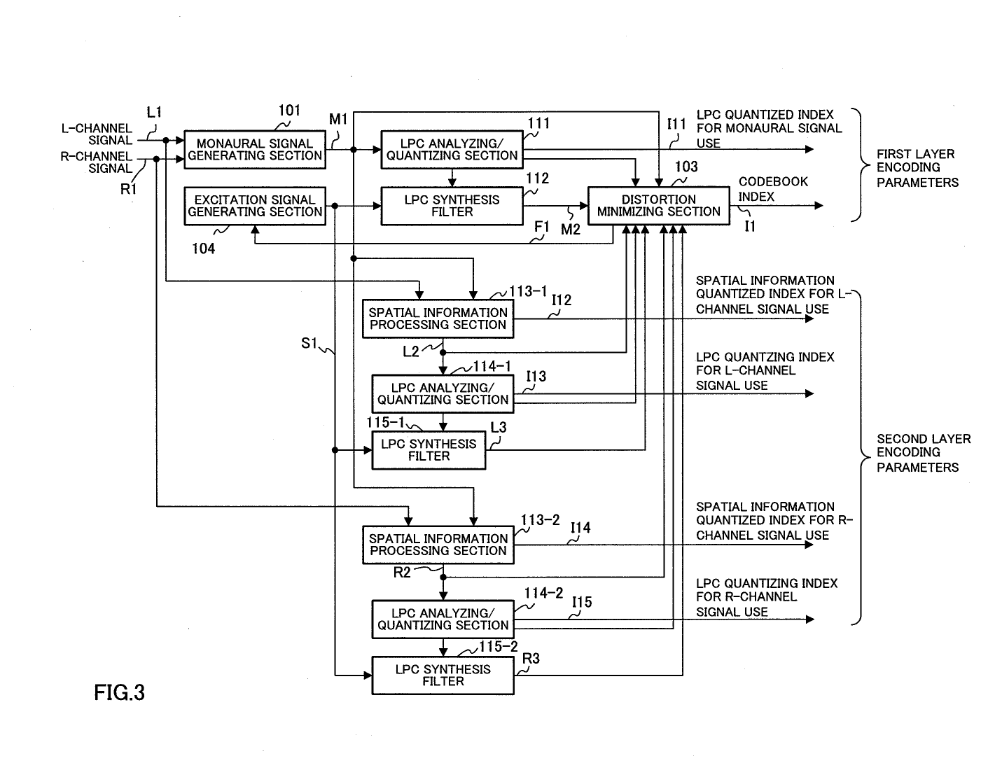

Next, a description will be given in the following of a detailed configuration for the scalable coding apparatus. FIG. 3 is a block diagram showing the configuration of the scalable coding apparatus according to Embodiment 1 shown in FIG. 1 in more detail. Here, the inputted signal is a speech signal and a description is given taking scalable coding apparatus employing CELP encoding as the encoding scheme as an example. Further, components and signals that are the same as in FIG. 1 will be assigned the same numerals and description thereof will be basically omitted.

This scalable coding apparatus separates the speech signal into vocal tract information and excitation information. The vocal tract information is then encoded by obtaining LPC parameters (linear prediction coefficients) at LPC analyzing/quantizing sections (111, 114-1, 114-2). The excitation information is then encoded by obtaining an index specifying which speech model stored in advance is used, i.e. by obtaining an index I1 specifying what kind of excitation vectors to generate using an adaptive codebook and a fixed codebook in excitation signal generating section 104.

In FIG. 3, LPC analyzing/quantizing section 111 and LPC synthesis filter 112 correspond to monaural signal synthesizing section 102 shown in FIG. 1, LPC analyzing/quantizing section 114-1 and LPC synthesis filter 115-1 correspond to L-channel processed signal synthesizing section 106-1 shown in FIG. 1, LPC quantizing/analyzing section 114-2 and LPC synthesis filter 115-2 correspond to R-channel processed signal synthesizing section 106-2 shown in FIG. 1, spatial information processing section 113-1 corresponds to L-channel signal processing section 105-1 shown in FIG. 1, and spatial information processing section 113-2 corresponds to R-channel signal processing section 105-2 shown in FIG. 1. Further, spatial information processing sections 113-1 and 113-2 generate, internally, L-channel spatial information and R-channel spatial information, respectively.

Specifically, each part of the scalable coding apparatus shown in the drawings operates as shown below. A description will be given with reference to the appropriate drawings.

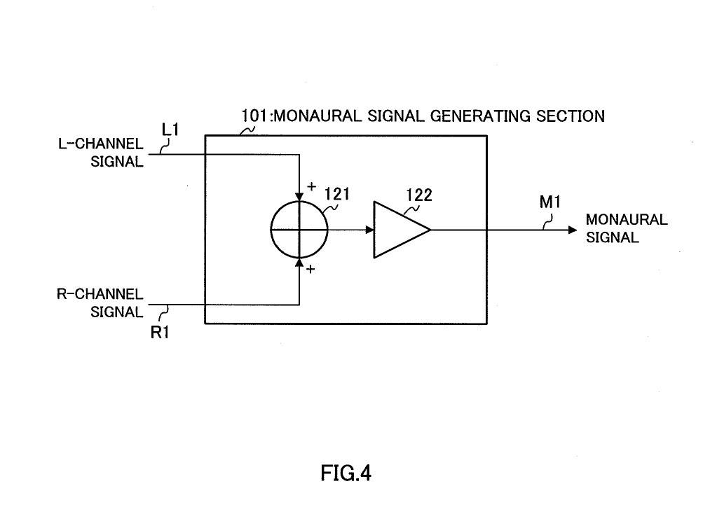

Monaural signal generating section 101 obtains the average for the inputted L-channel signal L1 and R-channel signal R1, and outputs this to monaural signal synthesizing section 102 as monaural signal M1. FIG. 4 is a block diagram showing the main configuration inside monaural signal generating section 101. Adder 121 obtains the sum of L-channel signal L1 and R-channel signal R1, and multiplier 122 outputs this sum signal in a ½ scale.

LPC analyzing/quantizing section 111 subjects monaural signal M1 to linear predictive analysis, outputs an LPC parameter representing spectral envelope information to distortion minimizing section 103, further quantizes this LPC parameter, and outputs the obtained quantized LPC parameter (LPC-quantized index for monaural signal) I11, to LPC synthesis filter 112 and to outside of scalable coding apparatus of this embodiment.

LPC synthesis filter 112, using quantized LPC parameters outputted by LPC analyzing/quantizing section 111 as filter coefficients, generates a synthesized signal using a filter function (i.e. an LPC synthesis filter) taking excitation vectors generated by an adaptive codebook and fixed codebook within excitation signal generating section 104 as an excitation. This synthesized signal M2 of the monaural signal is outputted to distortion minimizing section 103.

Spatial information processing section 113-1 generates L-channel spatial information indicating the difference in characteristics of L-channel signal L1 and monaural signal M1, from L-channel signal L1 and monaural signal M1. Further, spatial information processing section 113-1 subjects the L-channel signal L1 to processing using this L-channel spatial information and generates an L-channel processed signal L2 analogous to this monaural signal M1.

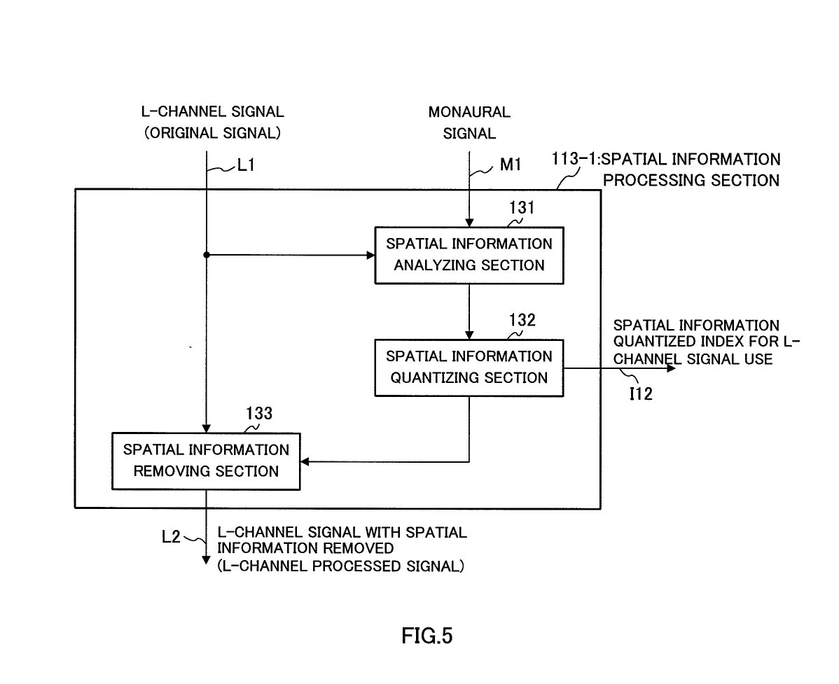

FIG. 5 is a block diagram showing the main configuration inside spatial information processing section 113-1.

Spatial information analyzing section 131 obtains the difference in spatial information between L-channel signal L1 and monaural signal M1 by comparative analysis of both channel signals, and outputs the obtained analysis result to spatial information quantizing section 132. Spatial information quantizing section 132 carries out quantization of the difference of spatial information between both channels obtained by spatial information analyzing section 131 and outputs the obtained encoding parameter (spatial information quantized index for L-channel signal) I12, to outside of the scalable coding apparatus of this embodiment. Further, spatial information quantizing section 132 subjects the spatial information quantized index for L-channel signal obtained by spatial information analyzing section 131 to dequantization for output to spatial information removing section 133. Spatial information removing section 133 converts L-channel signal L1 into a signal analogous to monaural signal M1 by removing the dequantized spatial information quantized index outputted by spatial information quantizing section 132 (i.e. the signal obtained by quantizing and then by dequantizing the difference of the spatial information between both channels obtained in spatial information analyzing section 131) from the L-channel signal L1. This L-channel signal L2 having spatial information removed (L-channel processed signal) is outputted to LPC analyzing/quantizing section 114-1.

Other than having L-channel processed signal L2 as input, the operation of LPC analyzing/quantizing section 114-1 is the same as LPC analyzing/quantizing section 111, where the obtained LPC parameter is outputted to distortion minimizing section 103, and LPC quantizing index I13 for L-channel signal is outputted to LPC synthesis filter 115-1 and to outside of scalable coding apparatus of this embodiment.

In the operation of LPC synthesis filter 115-1, the obtained synthesized signal L3 is outputted to distortion minimizing section 103, as with LPC synthesis filter 112.

Further, other than having the R-channel as the target of processing, the operation of spatial information processing section 113-2, LPC analyzing/quantizing section 114-2, and LPC synthesis filter 115-2 is the same as for spatial information processing section 113-1, LPC analyzing/quantizing section 114-1 and LPC synthesis filter 115-1, except that the R-channel is the target of processing, and therefore will not be described.

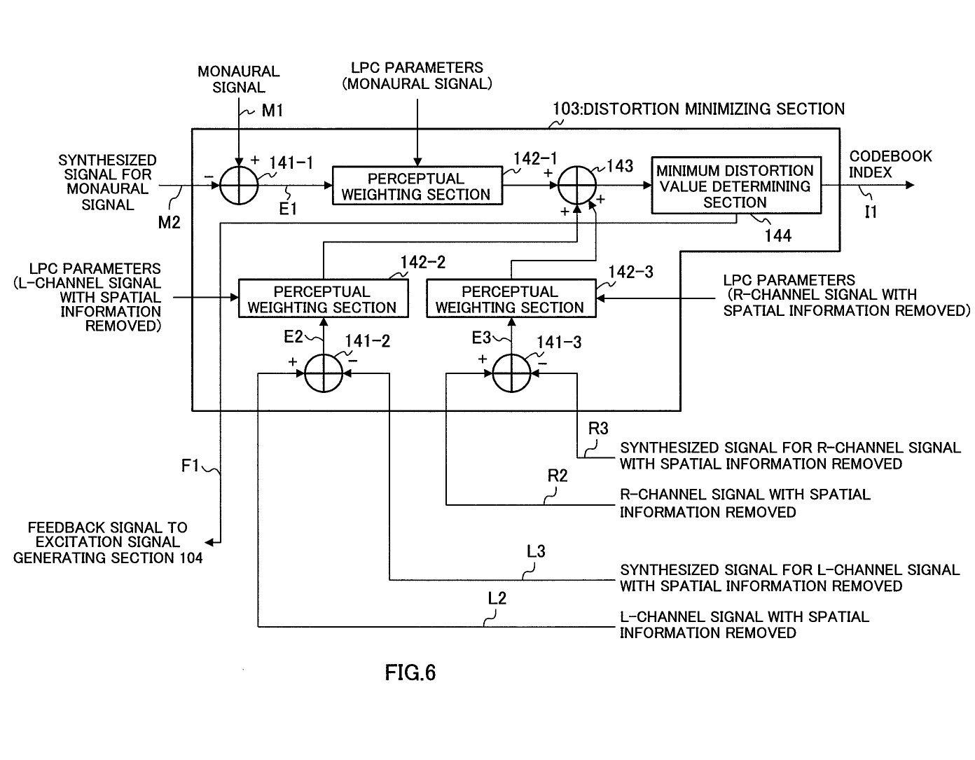

FIG. 6 is a block diagram showing the main configuration inside distortion minimizing section 103.

Adder 141-1 calculates error signal E1 by subtracting synthesized signal M2 of this monaural signal from monaural signal M1, and outputs error signal E1 to perceptual weighting section 142-1.

Perceptual weighting section 142-1 subjects encoding distortion E1 outputted from adder 114-1 to perceptual weighting using an perceptual weighting filter taking LPC parameters outputted by LPC analyzing/quantizing section 111 as filter coefficients for output to adder 143.

Adder 141-2 calculates error signal E2 by subtracting, from L-channel signal (L-channel processed signal) L2 having spatial information removed, synthesized signal L3 for this signal, and outputs the error signal E2 to perceptual weighting section 142-2.

The operation of perceptual weighting section 142-2 is the same as for perceptual weighting section 142-1.

As with adder 141-2, adder 141-3 also calculates error signal E3 by subtracting, from R-channel signal (R-channel processed signal) R2 having spatial information removed, synthesized signal R3 for this signal, and outputs the error signal E3 to perceptual weighting section 142-3.

The operation of perceptual weighting section 142-3 is the same as for perceptual weighting section 142-1.

Adder 143 adds the error signals E1 to E3 outputted from perceptual weighting sections 142-1 to 142-3 after perceptual weight assignment, for output to minimum distortion value determining section 144.

Minimum distortion value determining section 144 obtains the index for each codebook (adaptive codebook, fixed codebook, and gain codebook) in excitation signal generating section 104 on a per subframe basis, such that encoding distortion obtained from the three error signals becomes small taking into consideration all of perceptual weight assigned error signals E1 to E3 outputted from perceptual weighting sections 142-1 to 142-3. These codebook indexes I1 are outputted to outside of the scalable coding apparatus of this embodiment as encoding parameters.

Specifically, minimum distortion value determining section 144 expresses encoding distortion by the squares of error signals, and obtains the index for each codebook in excitation signal generating section 104 by, such that a total E1²+E2²+E3² of encoding distortions obtained from error signals outputted from perceptual weighting sections 142-1 to 142-3 becomes a minimum. This series of processes for obtaining index forms a closed loop (feedback loop). Here, minimum distortion value determining section 144 indicates the index of each codebook to excitation signal generating section 104 using feedback signal F1. Each codebook is searched by making changes within one subframe, and the actually obtained index I1 for each codebook is outputted to outside of scalable coding apparatus of this embodiment.

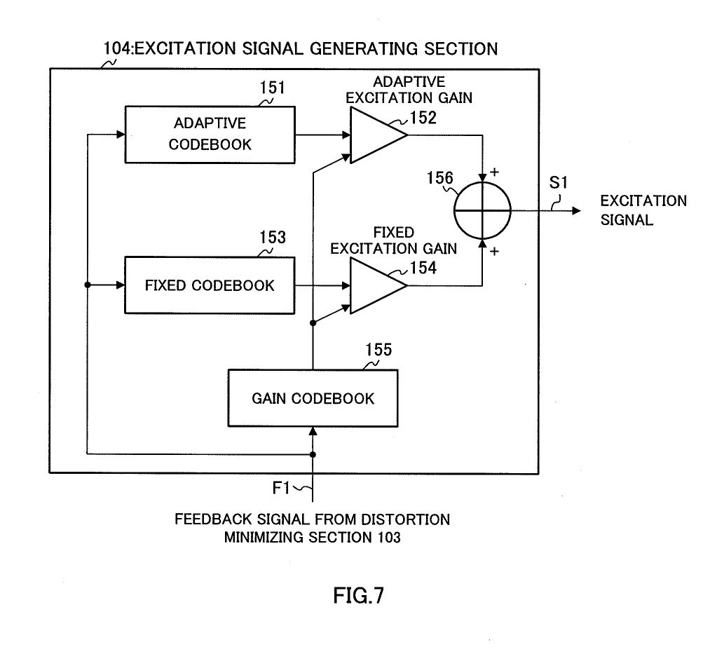

FIG. 7 is a block diagram showing the main configuration inside excitation signal generating section 104.

Adaptive codebook 151 generates one subframe of excitation vector in accordance with the adaptive codebook lag corresponding to the index specified by distortion minimizing section 103. This excitation vector is outputted to multiplier 152 as an adaptive codebook vector. Fixed codebook 153 stores a plurality of excitation vectors of predetermined shapes in advance, and outputs an excitation vector corresponding to the index specified by distortion minimizing section 103 to multiplier 154 as a fixed codebook vector. Gain codebook 155 generates gain (adaptive codebook gain) for use with the adaptive codebook vector outputted by adaptive codebook 151 in accordance with command from distortion minimizing section 103 and generates gain (fixed codebook gain) for use with the fixed codebook vector outputted from fixed codebook 153, for respective output to multipliers 152 and 154.

Multiplier 152 multiplies the adaptive codebook vector outputted by adaptive codebook 151 by the adaptive codebook gain outputted by gain codebook 155 for output to adder 156. Multiplier 154 multiplies the fixed codebook vector outputted by fixed codebook 153 by the fixed codebook gain outputted by gain codebook 155 for output to adder 156. Adder 156 then adds the adaptive codebook vector outputted by multiplier 152 and the fixed codebook vector outputted by multiplier 154, and outputs the excitation vector for after addition as excitation signal S1.

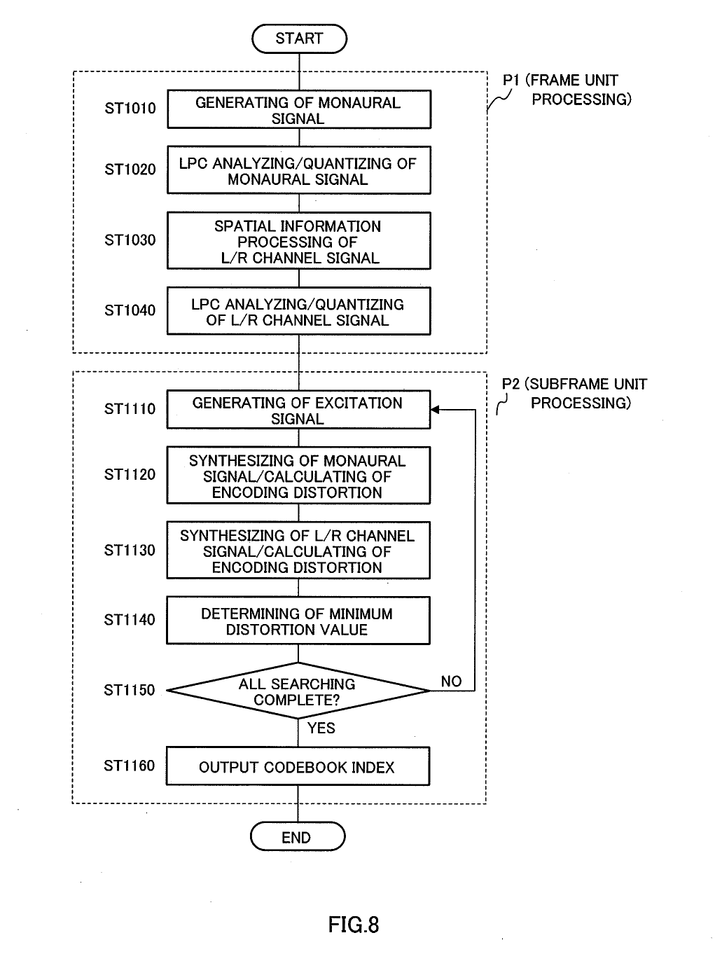

FIG. 8 is a flowchart illustrating the steps of scalable coding processing described above.

Monaural signal generating section 101 has the L-channel signal and the R-channel signal as input signals, and generates a monaural signal using these signals (ST1010). LPC analyzing/quantizing section 111 then carries out LPC analysis and quantization of the monaural signal (ST1020). Spatial information processing sections 113-1 and 113-2 carry out spatial information processing, i.e. extraction and removal of spatial information on the L-channel signal and R-channel signal (ST1030). LPC analyzing/quantizing sections 114-1 and 114-2 similarly perform LPC analysis and quantization on the L-channel signal and R-channel signal having spatial information removed in the same way as for the monaural signal (ST1040). The processing from the monaural signal generation in ST1010 to the LPC analysis/quantization in ST1040, will be referred to, collectively, as process P1.

Distortion minimizing section 103 decides the index for each codebook so that encoding distortion of the three signals becomes a minimum (process P2). Namely, an excitation signal is generated (ST1110) , calculation of synthesizing/encoding distortion of the monaural signal is carried out (ST1120), calculation of synthesizing/encoding distortion of the L-channel signal and the R-channel signal is carried out (ST1130), and determination of the minimum value of the encoding distortion is carried out (ST1140). Processing for searching the codebook indexes of ST1110 to 1140 is a closed loop, searching is carried out for all indexes, and the loop ends when all of the searching is complete (ST1150). Distortion minimizing section 103 then outputs the obtained codebook index (ST1160).

In the processing steps described above, process P1 is carried out in frame units, and process P2 is carried out in frames further divided into subframe units.

Further, a case has been described above in the processing steps described above where ST1020 and ST1030 to ST1040 are carried out in this order, but it is also possible to carry out ST1020 and ST1030 to ST1040 at the same time (i.e. parallel processing). Further, with ST1120 and ST1130 also, these steps may also be carried out in parallel.

Next, a detailed description will be given of processing for each section of spatial information processing section 113-1 using mathematical equations. The description of spatial information processing section 113-2 is the same as for spatial information processing section 113-1 and will be therefore omitted.

First, a description will be given of an example of the case of using the energy ratio and delay time difference between two channels as spatial information.

Spatial information analyzing section 131 calculates an energy ratio between two channels in frame units. First, energy E_{LCh} and E_{M} of one frame of the L-channel signal and monaural signal can be obtained in accordance with equation 1 and equation 2 in the following.

[1]

$$\begin{matrix} {E}_{Lch} = {\sum }_{n = 0}^{FL - 1} {{x}_{Lch} ( n )}^{2} & ( Equation 1 ) \\ {E}_{M} = {\sum }_{n = 0}^{FL - 1} {{x}_{M} ( n )}^{2} & ( Equation 2 )\end{matrix}$$

[2]

$$\begin{matrix}[ Equation 2 ] & \\ {E}_{M} = {\sum }_{n = 0}^{FL - 1} {{x}_{M} ( n )}^{2} & [ 2 ]\end{matrix}$$

Here, n is the sample number, and FL is the number of samples for one frame (i.e. frame length). Further, x_{Lch}(n) and x_{M}(n) indicate amplitude of the nth sample of each L-channel signal and monaural signal.

Spatial information analyzing section 131 then obtains the square root C of the energy ratio of the L-channel signal and monaural signal in accordance with the next equation 3.

[3]

$$C = \sqrt{\frac{{E}_{Lch}}{{E}_{M}}} \qquad ( Equation 3 )$$

Further, spatial information analyzing section 131 obtains the delay time difference, which is the amount of time shift between two channel signals of the L-channel signal and the monaural signal, such that the delay time difference has a value at which cross correlation between the two channel signals becomes a maximum. Specifically, the cross correlation function Φ for the monaural signal and the L-channel signal can be obtained in accordance with the following equation 4.

[4]

$$φ ( m ) = {\sum }_{n = 0}^{FL - 1} {x}_{Lch} ( n ) \cdot {x}_{M} ( n - m ) \qquad ( Equation 4 )$$

Here, m is taken to be a value in the range from min_m to max_m defined in advance, and m=M for the time where Φ(m) is a maximum is taken to be the delay time with respect to the monaural signal of the L-channel signal.

The energy ratio and delay time difference described above may also be obtained using the following equation 5. In equation 5, the energy ratio square root C and delay time m are obtained in such a manner that the difference D between the monaural signal and the L-channel signal where the spatial information is removed, becomes a minimum.

[5]

$$D = {\sum }_{n = 0}^{FL - 1} {\{ {x}_{Lch} ( n ) - C \cdot {x}_{M} ( n - m ) \}}^{2} \qquad ( Equation 5 )$$

Spatial information quantizing section 132 quantizes C and M described above using a predetermined number of bits and uses the quantized values C and M as C_{Q} and M_{Q}, respectively.

Spatial information removing section 133 removes spatial information from the L-channel signal in accordance with the conversion method of the following equation 6.

[6]

x′_{Lch}(n)=C_{Q}·x_{Lch}(n−M_{Q}) (Equation 6)

(where n=0, . . . , FL−1)

Further, the following is also given as a specific example of the above spatial information.

For example, it is also possible to use two parameters of energy ratio and delay time difference for between the two channels as spatial information. These are parameters that are easy to quantify. Further, it is possible to use propagation characteristics such as, for example, phase difference and amplitude ratio etc. in every frequency band, for variations.

As described above, according to this embodiment, signals that are the target of encoding are made similar and are encoded using a common excitation, so that it is possible to prevent deterioration in sound quality of the decoded signal, reduce the encoding bit rate and reduce the circuit scale.

Further, in each layer, signals are encoded using a common excitation, so that it is not necessary to provide a set of an adaptive codebook, fixed codebook, and gain codebook for every layer, and it is possible to generate an excitation using one set of these codebooks. That is to say, circuit scale can be reduced.

Further, in the above configuration, distortion minimizing section 103 takes into consideration encoding distortion of all of the monaural signal, L-channel signal, and R-channel signal, and carries out control so that the total of these encoding distortions becomes a minimum. As a result, coding performance improves, and it is possible to improve the quality of the decoded signals.

Although a case has been described in FIG. 3 onwards of this embodiment where CELP encoding is used as the encoding scheme, but the present invention is by no means limited to encoding using a speech model such as CELP encoding or to the coding method utilizing excitations preregistered in a codebook.

Further, although a case has been described with this embodiment where all of the encoding distortion for the three signals of the monaural signal, L-channel processed signal, and R-channel processed signal are taken into consideration, given that the monaural signal, L-channel processed signal, and R-channel processed signal are analogous to each other, it is equally possible to obtain an encoding parameter making encoding distortion a minimum for only one channel—for example, for the monaural signal alone—and transmit this encoding parameter to the decoding side. In this case also, on the decoding side, encoding parameters of the monaural signal are decoded and it is then possible to reproduce this monaural signal. For the L-channel and R-channel also, it is also possible to reproduce signals for both channels without substantial reduction in quality by decoding encoding parameters for L-channel spatial information and R-channel spatial information outputted by scalable coding apparatus of this embodiment and subjecting the decoded monaural signal to processing that is the reverse of the aforementioned processing.

Further, in this embodiment, a description is given of an example of the case where both two parameters of energy ratio and delay time difference between two channels (for example, the L-channel and the monaural signal) are adopted as spatial information but it is also possible to use either one of the parameters as spatial information. In the case of using just one parameter, the effect of increasing similarity of the two channels is reduced compared to the case of using two parameters, but, conversely, there is the effect that the number of coding bits can be further reduced.

For example, in the case of using only energy ratio between two channels as spatial information, conversion of the L-channel signal is carried out in accordance with the following equation 7 using a quantized value C_{Q} for the square root C of the energy ratio obtained using equation 3 above.

[7]

x′_{Lch}(n)=C_{Q}·x_{Lch}(n) (Equation 7)

(where n=0, . . . , FL−1)

The square root C_{Q} of the energy ratio in equation 7 can be referred to be the amplitude ratio (where the sign is only positive), and the amplitude of x_{Lch}(n) can be converted by multiplying x_{LCh}(n) by C_{Q} (i.e. the amplitude attenuated by the distance from the excitation can be corrected), and this is equivalent to removing the influence of distance in spatial information.

For example, in the case of using only delay time difference between two channels as spatial information, conversion of the sub-channel signals is carried out in accordance with the following equation 8 using a quantized value M_{Q} of m=M taking a maximum for Φ(m) obtained using equation 4 above.

[8]

x′_{Lch}(n)=x_{Lch}(n−M_{Q}) (Equation 8)

(where n=0, . . . FL−1)

M_{Q} in equation 8 which maximizes Φ is a value representing time in a discrete manner, and so replacing “n” in x_{Lch}(n) with n−M_{Q} would be equal to conversion to waveform (advanced by just a time M) x_{Lch}(n) that is M backward in time (that is, M earlier). Namely, the waveform is delayed by M, and this is equal to eliminating the influence of distance in the spatial information. The direction of the sound source being different means that the distance is also different, and the influence of direction is therefore also taken into consideration.

Further, as with the L-channel signal and R-channel signal having spatial information removed, upon quantization in the LPC quantizing section, it is possible to carry out, for example, differential quantization and predictive quantization, using quantized LPC parameters quantized with respect to the monaural signal. The L-channel signal and the R-channel signal having spatial information removed, are converted to signals close to the monaural signal. The LPC parameters for these signals therefore have a high correlation with the LPC parameters for the monaural signal, and it is possible to carry out efficient quantization at a lower bit rate.

Further, at distortion minimizing section 103, it is also possible to set weighting coefficients α, β, γ in advance as shown in equation 9 in the following, so that the contribution of encoding distortion of either of the monaural signal or the stereo signal becomes less during encoding distortion calculation.

Encoding distortion=α×monaural signal encoding distortion+×L channel signal encoding distortion+γ×R channel signal encoding distortion (Equation 9)

In this way, it is possible to implement encoding suitable for the environment by making the weighting coefficient for the signal (i.e. the signal it is wished to encode at high sound quality) , for which it is wished to make the influence of encoding distortion less, larger than weighting coefficients for other signals. For example, upon decoding, in the case of encoding a signal that is more often decoded using a stereo signal than using monaural signal, for the weighting coefficients, β and γ are set to be greater values than α, and at this time the same value is used for β and γ.

Further, as a variation of the method for setting the weighting coefficients, it is also possible to consider only encoding distortion of a stereo signal and not consider encoding distortion of the monaural signal. In this case, α is set to 0. β and γ are set to the same value (for example, 1).

Further, in the case that important information is contained in the signal of one of the channels (for example, the L-channel signal) of the stereo signal (for example, the L-channel signal is speech and the R-channel signal is background music), then, for the weighting coefficients, a larger value for β than for γ.

Further, it is also possible to search for parameters of the excitation signal such that encoding distortion of only two signals of the monaural signal and the L-channel signal having spatial information removed, is made a minimum, and, as for LPC parameters, it is possible to carry out quantization for the two signals alone. In this case, the R-channel signal can be obtained from the following equation 10. Moreover, it is also possible to reverse the L-channel signal and the R-channel signal.

R(i)=2×M(i)−L(i) (Equation 10)

Here, R(i) is the amplitude value of the i-th sample of the R channel signal, M(i) is the amplitude value of the i-th sample of the monaural signal, and L(i) is the amplitude value of the i-th sample of the L-channel signal.

Further, if the monaural signal, L-channel processed signal, and R-channel processed signal are mutually similar, it is possible for the excitation to be shared. In this embodiment, it is possible to achieve the same operation and results not just for processing such as eliminating spatial information, but also by utilizing other processing.

### Embodiment 2

In Embodiment 1, distortion minimizing section 103 takes into consideration encoding distortion of all of the monaural signal, L-channel, and R-channel and carries out control of an encoding loop so that the total of these encoding distortions becomes a minimum. More specifically, as for the L-channel signal, distortion minimizing section 103 obtains and uses encoding distortion between the L-channel signal having spatial information removed, and the synthesized signal for the L-channel signal having spatial information removed, for example, and these signals are provided after the spatial information is eliminated and therefore have properties closer to those of a monaural signal than the L-channel signal. Namely, the target signal in the encoding loop is not the source signal but rather is a signal that is subjected to predetermined processing.

Here, in this embodiment, the source signal is used as a target signal in the encoding loop at distortion minimizing section 103. On the other hand, in the present invention, there is no synthesized signal for the source signal. Therefore, for example, as for the L-channel, a mechanism for again attaching spatial information to the synthesized signal for the L-channel signal having spatial information removed, may be provided, obtaining the L-channel synthesized signal having spatial information restored and calculating encoding distortion from this synthesized signal and the source signal (L-channel signal).

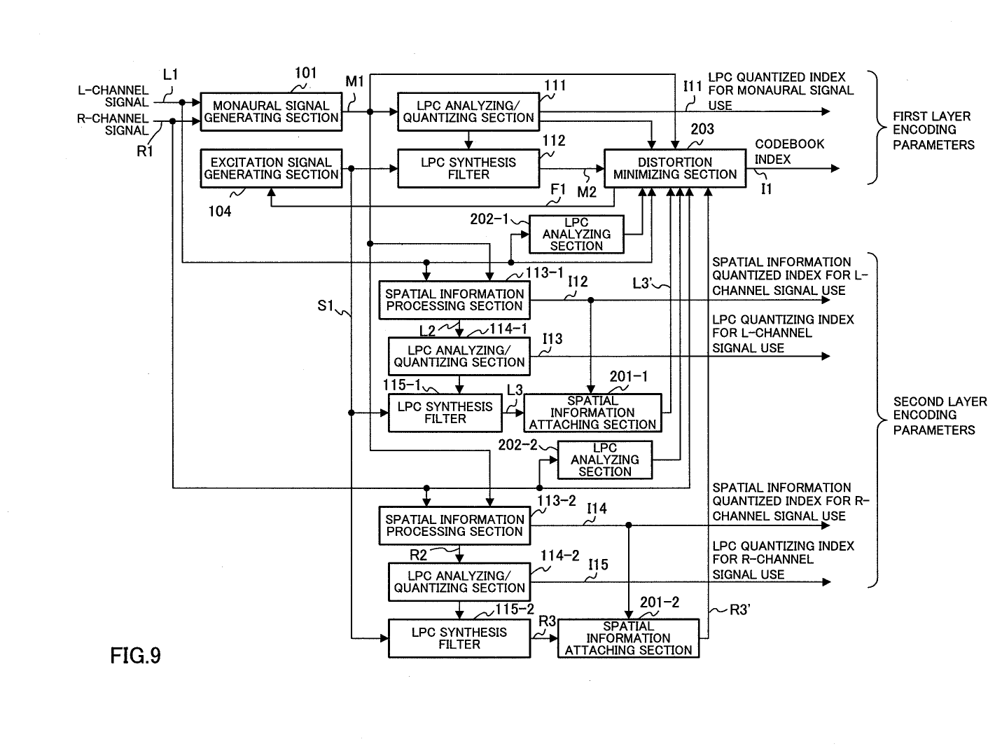

FIG. 9 is a block diagram showing a detailed configuration of a scalable coding apparatus according to Embodiment 2 of the invention. This scalable coding apparatus has a basic configuration same as the scalable coding apparatus (see FIG. 3) shown in Embodiment 1 and the same components are assigned the same reference numerals and their explanations will be omitted.

The scalable coding apparatus according to this embodiment provides, in addition to the configuration of Embodiment 1, spatial information attaching sections 201-1 and 201-2, and LPC analyzing sections 202-1 and 202-2. Further, the function of the distortion minimizing section controlling the encoding loop is different from Embodiment 1 (i.e. distortion minimizing section 203).

Spatial information attaching section 201-1 assigns spatial information eliminated by spatial information processing section 113-1 to synthesized signal L3 outputted by LPC synthesis filter 115-1 for output to distortion minimizing section 203 (L3′). LPC analyzing section 202-1 carries out linear prediction analysis on L-channel signal L1 that is the source signal, and outputs the obtained LPC parameter to distortion minimizing section 203. The operation of distortion minimizing section 203 is described in the following.

The operation of spatial information attaching section 201-2 and LPC analyzing section 202-2 is the same as described above.

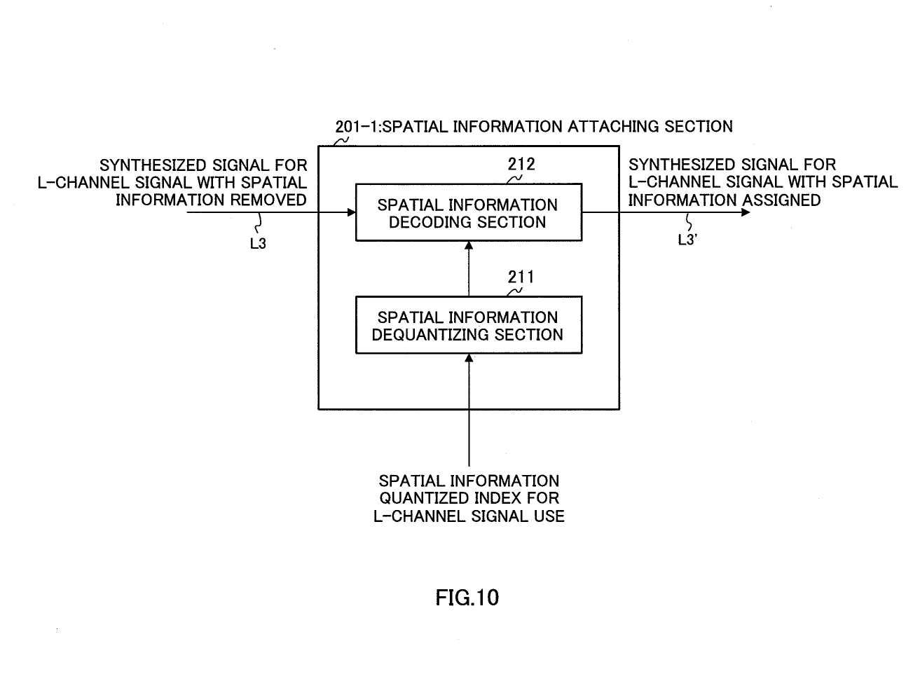

FIG. 10 is a block diagram showing the main configuration inside spatial information attaching section 201-1. The configuration of spatial information attaching section 201-2 is the same.

Spatial information attaching section 201-1 is equipped with spatial information dequantizing section 211 and spatial information decoding section 212. Spatial information dequantizing section 211 dequantizes inputted spatial information quantizing indexes C_{Q} and M_{Q} for L-channel signal, and outputs spatial information quantized parameters C′ and M′ for the monaural signal of the L-channel signal, to spatial information decoding section 212. Spatial information decoding section 212 generates and outputs L-channel synthesized signal L3′ with spatial information attached, by applying spatial information quantizing parameters C′ and M′ to synthesized signal L3 for the L-channel signal having spatial information removed.

Next, a mathematical equation for illustrating processing in spatial information attaching section 201-1 is shown in the following. This processing is only the reverse of the processing at spatial information processing section 113-1 and is therefore will not be described in detail.

For example, in the case of using the energy ratio and delay time differences as spatial information, the following equation 11 is given corresponding to equation 6 above.

[9]

$${x}_{Lch}^{″} ( n ) = \frac{1}{{C}^{′}} \cdot {x}_{Lch} ( n + {M}^{′} ) \\ ( where n = 0 , … , FL - 1 ) \qquad ( Equation 11 )$$

Further, in the case of using only the energy ratio as spatial information, the following equation 12 is given corresponding to equation 7 above.

[10]

$${x}_{Lch}^{″} ( n ) = \frac{1}{{C}^{′}} \cdot {x}_{Lch} ( n ) \\ ( where n = 0 , … , FL - 1 ) \qquad ( Equation 12 )$$

Further, in the case of using only delay time difference as spatial information, the following equation 13 is given corresponding to equation 8 above.

[11]

$${x}_{Lch}^{″} ( n ) = {x}_{Lch} ( n + {M}^{′} ) \\ ( where n = 0 , … , FL - 1 ) \qquad ( Equation 13 )$$

A description is given using the same mathematical equation as for the R-channel signal.

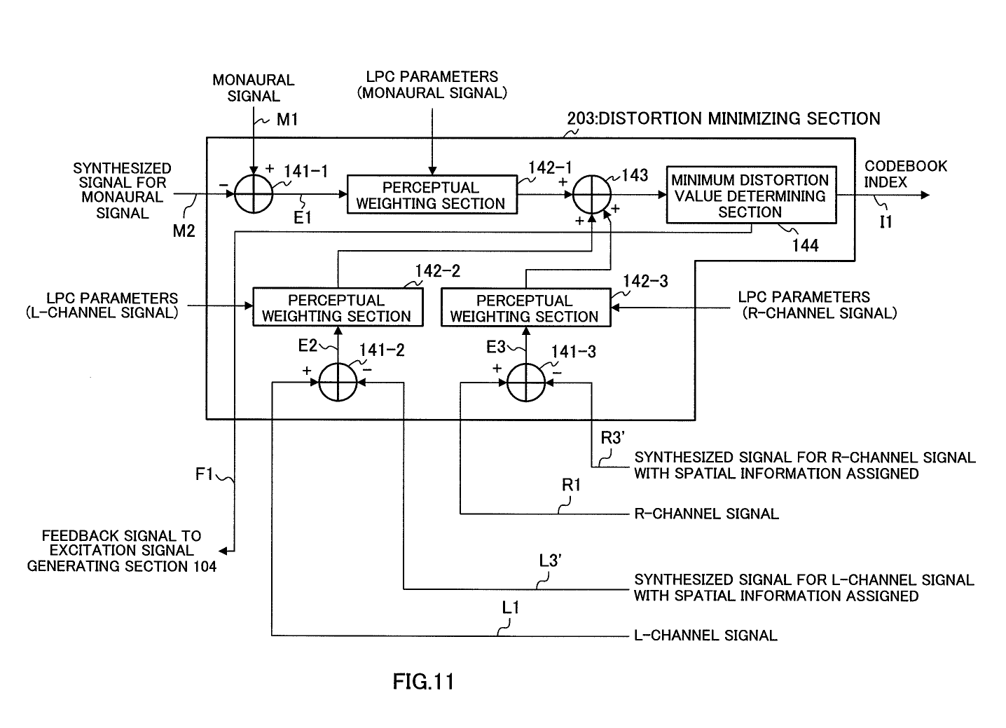

FIG. 11 is a block diagram showing the main configuration inside distortion minimizing section 203. Elements of the configuration that are the same as distortion minimizing section 103 shown in Embodiment 1 are given the same numerals and are not described.

Monaural signal M1 and synthesized signal M2 for the monaural signal, L-channel signal L1 and synthesized signal L3′ provided with spatial information for this L-channel signal L1, and R-channel signal R1 and synthesized signal R3′ provided with spatial information for this R-channel signal R1, are inputted to distortion minimizing section 203. Distortion minimizing section 203 calculated encoding distortion for between these signals, calculates the total encoding distortions by carrying out perceptual weight assignment, and decides the index of each codebook that makes encoding distortion a minimum.

Further, LPC parameters for the L-channel signal are inputted to perceptual weighting section 142-2, and perceptual weighting section 142-2 assigns perceptual weight using the inputted LPC parameters as filter coefficients. Further, LPC parameters for the R-channel signal are inputted to perceptual weighting section 142-3, and perceptual weighting section 142-3 assigns perceptual weight taking the inputted LPC parameters as filter coefficients.

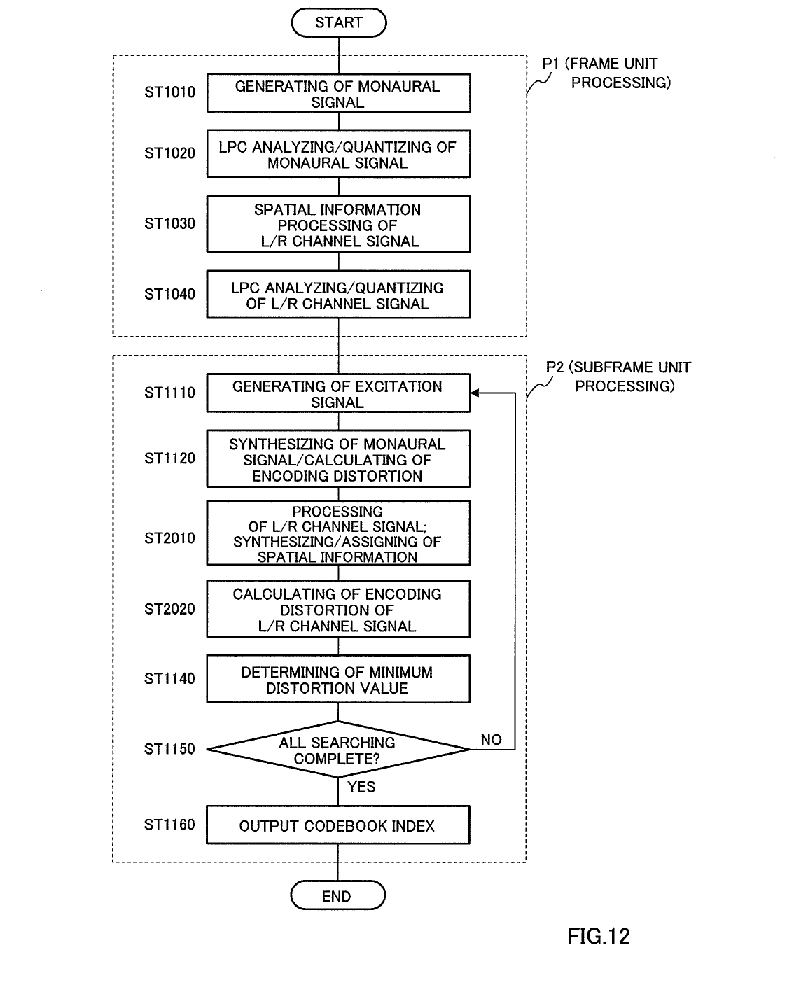

FIG. 12 is a flowchart illustrating the steps of scalable coding processing described above.

Differences from FIG. 8 shown in Embodiment 1 include having a step (ST2010) of synthesis of the L/R channel signal and spatial information attachment and a step (ST2020) of calculating encoding distortion of the L/R channel signal, instead of ST1130.

According to this embodiment, the L-channel signal or R-channel signal, which is the source signals, is used as target signal in the encoding loop rather than using a signal that has been subjected to predetermined processing as in Embodiment 1. Further, given that the source signal is the target signal, an LPC synthesized signal with spatial information restored is used as the corresponding synthesized signal. Improvement in the accuracy of coding is therefore anticipated.

For example, in Embodiment 1, the encoding loop operates such that encoding distortion of the signal synthesized from a signal where spatial information is removed becomes a minimum with respect to the L-channel signal and the R-channel signal. There is therefore the fear that the encoding distortion of the actually outputted decoded signal is not a minimum.

Further, for example, in the case that the amplitude of the L-channel signal is significantly large compared to the amplitude of the monaural signal, in the method of Embodiment 1, this is a signal where the influence of this amplitude being large is eliminated from the error signal for the L-channel signal inputted to the distortion minimizing section. Therefore, upon restoration of the spatial information in the decoding apparatus, unnecessary encoding distortion also increases in accompaniment with increase in amplitude and quality of reconstructed sound deteriorates. On the other hand, in this embodiment, minimization is carried out taking encoded distortion contained in the same signal as the decoded signal obtained by the decoding apparatus as a target, and therefore the above problem does not apply.

Further, in the above configuration, LPC parameters obtained from the L-channel signal and R-channel signal without having spatial information removed, are employed as LPC parameters used in perceptual weight assignment. Namely, in perceptual weight assignment, perceptual weight is applied to the L-channel signal or R-channel signal itself that is the source signal. As a result, it is possible to carry out high sound quality encoding on the L-channel signal and R-channel signal with little perceptual distortion.

This concludes the description of the embodiments of the present invention.

The scalable coding apparatus and scalable coding method according to the present invention are not limited to the embodiments described above, and may include various types of modifications.

The scalable coding apparatus of the present invention can be mounted in a communication terminal apparatus and a base station apparatus in a mobile communication system, thereby providing a communication terminal apparatus and a base station apparatus that have the same operational effects as those described above. The scalable coding apparatus and scalable coding method according to the present invention are also capable of being utilized in wired communication schemes.

A case has been described here as an example in which the present invention is configured with hardware, but the present invention can also be implemented as software. For example, by describing the algorithm of the process of the scalable coding method according to the present invention in a programming language, storing this program in a memory and making an information processing section execute this program, it is possible to implement the same function as the scalable coding apparatus of the present invention.

The adaptive codebook may be referred to as an adaptive excitation codebook. Further, the fixed codebook may be referred to as a fixed excitation codebook. In addition, the fixed codebook may be referred to as a noise codebook, stochastic codebook or a random codebook.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC”, “system LSI”, “super LSI”, or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology.

Application in biotechnology is also possible.

The present application is based on Japanese Patent Application No. 2004-381492, filed on Dec. 28, 2004, and Japanese Patent Application No. 2005-160187, filed on May 31, 2005, the entire content of which is expressly incorporated by reference herein.

### INDUSTRIAL APPLICABILITY

The scalable coding apparatus and scalable coding method according to the invention are applicable for use with communication terminal apparatus, base station apparatus, etc. in a mobile communication system.

1. A scalable coding apparatus comprising:
a monaural signal generating section that generates a monaural signal from a first channel signal and a second channel signal;
a first channel processing section that processes the first channel signal and generates a first channel processed signal analogous to the monaural signal;
a second channel processing section that processes the second channel signal and generates a second channel processed signal analogous to the monaural signal;
a first encoding section that encodes part or all of the monaural signal, the first channel processed signal, and the second channel processed signal, using a common excitation; and
a second encoding section that encodes information relating to the process in the first channel processing section and the second channel processing section.

2. The scalable coding apparatus according to claim 1, wherein:
the first channel processing section applies corrections to spatial information contained in the first channel signal and generates the first channel processed signal;
the second channel processing section applies corrections to spatial information contained in the second channel signal and generates the second channel processed signal; and
the second encoding section encodes information relating to the corrections applied in the first channel processing section and the second channel processing section.

3. The scalable coding apparatus according to claim 2, wherein the spatial information contained in the first channel signal includes information relating to differences between waveforms of the first channel signal and the monaural signal.

4. The scalable coding apparatus according to claim 3, wherein the information relating to the differences between waveforms includes information relating to one or both of energy and delay time.

5. The scalable coding apparatus according to claim 1, wherein the first encoding section comprises an adaptive codebook and a fixed codebook that are common to part or all of the monaural signal, the first channel processed signal, and the second channel processed signal.

6. The scalable coding apparatus according to claim 1, wherein the first encoding section obtains the common excitation such that a total of encoding distortion of the monaural signal, encoding distortion of the first channel processed signal, and encoding distortion of the second channel processed signal, is a minimum.

7. The scalable coding apparatus according to claim 1, further comprising:
a first reverse processing section that subjects the first channel processed signal to process that is a reverse of the process in the first processing section and obtains the first channel signal; and
a second reverse processing section that subjects the second channel processed signal to process that is a reverse of the process in the second processing section and obtains the second channel signal, wherein the first encoding section obtains the common excitation such that a total of encoding distortion of the monaural signal, encoding distortion of the first channel signal obtained in the first reverse processing section, and encoding distortion of the second channel signal obtained in the second reverse processing section, is a minimum.

8. The scalable coding apparatus according to claim 7, further comprising:
a monaural LPC analyzing section that subjects the monaural signal to LPC analysis and obtains a monaural LPC parameter;
a first channel LPC analyzing section that subjects the first channel signal to LPC analysis and obtains a first channel LPC parameter;
a second channel LPC analyzing section that subjects the second channel signal to LPC analysis and obtains a second channel LPC parameter;
a monaural perceptual weighting section that assigns perceptual weight to the encoding distortion of the monaural signal using the monaural LPC parameters;
a first channel perceptual weighting section that assigns perceptual weight to encoding distortion of the first channel signal obtained by the first reverse processing section using the first channel LPC parameter; and
a second channel perceptual weighting section that assigns perceptual weight to encoding distortion of the second channel signal obtained in the second reverse processing section using the second channel LPC parameter.

9. A communication terminal apparatus comprising the scalable coding apparatus of claim 1.

10. A base station apparatus comprising the scalable coding apparatus of claim 1.

11. A scalable coding method comprising:
a monaural signal generating step of generating a monaural signal from a first channel signal and a second channel signal;
a first channel processing step of process the first channel signal and generating a first channel processed signal analogous to the monaural signal;
a second channel processing step of processing the second channel signal and generating a second channel processed signal analogous to the monaural signal;
a first encoding step of encoding part or all of the monaural signal, the first channel processed signal, and the second channel processed signal, using a common excitation; and
a second encoding step of encoding information relating to the process in the first channel processing step and the second channel processing step.
